(19) United States
(12) Patent Application Publication
(10) Pub. No.: US 2014/0141977 A1
(43) Pub. Date: May 22, 2014

(54) Suspension Concentrates

(71) Applicants: Andreas Wacker, Mannheim (DE); Carsten Schaefer, Muhldorf (DE); Alexander Woerndale, Frankfurt am Main (DE); Robert Milbradt, Wiesbaden (DE)

(72) Inventors: Andreas Wacker, Mannheim (DE); Carsten Schaefer, Muhldorf (DE); Alexander Woerndale, Frankfurt am Main (DE); Robert Milbradt, Wiesbaden (DE)

(73) Assignee: CLARIANT FINANCE (BVI) LIMITED, Tortola (VG)

(21) Appl. No.: 14/004,993

(22) PCT Filed: Mar. 10, 2012
(86) PCT No.: PCT/EP2012/001080

§ 371 Date: Dec. 20, 2013

(30) Foreign Application Priority Data
Mar. 17, 2011 (DE) 10 2011 014 354.8

(51) Int. Cl. A01N 25/04; A01N 57/20; A01N 43/653; A01N 43/70; A01N 43/54; A01N 43/50

(52) U.S. Cl. CPC A01N 25/04; A01N 43/54; A01N 43/50; A01N 43/653; A01N 43/70; A01N 57/20
USPC 504/128; 514/269; 514/341; 514/383; 504/234

(57) ABSTRACT

The invention relates to suspension concentrates comprising a) one or more pesticides that are solid at room temperature, b) one or more specific copolymers, c) one or more additional auxiliary substances as applicable and d) one or more solvents. The copolymers b) comprise structural units of formula (I), wherein A stands for C₂-C₄-alkyls, B stands for a C₂-C₄-alkyl different from A, R stands for hydrogen or methyl, m is a number from 1 to 500, n is a number from 1 to 500, the sum of m+n is equal to 2 to 1000 and P stands for H or for a specific other concluding group, and structural units derived from specific ethylenic, unsaturated monomers that comprise an aromatic group, and structural units derived from specific ethylenic, unsaturated monomers that comprise aliphatic hydrocarbon residue. The suspension concentrates according to the invention are advantageously suitable for use as pesticides.

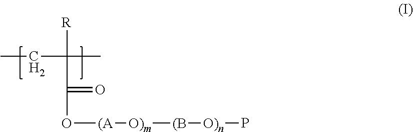

The present invention relates to suspension concentrates comprising copolymers, and to their use as crop protection compositions.

Pesticides are usually used in the form of preparations in order to achieve a better utilization of the active ingredients. Such preparations are also referred to as formulations and are generally in solid form or in liquid form. Liquid pesticide preparations have the advantage that they are easier to dose for the user and can be distributed homogeneously in the spray liquor. Modern pesticides are mostly complex organic molecules which have only a low solubility in water or other solvents. These pesticides are therefore expediently provided in dispersed form as suspension concentrates.

To stabilize pesticides in suspension concentrates, dispersants are required. These dispersants, optionally supported by suitable surface-active substances (wetting agents), permit the preparation of the suspension concentrate, which is generally accomplished with the help of grinding in order to introduce high mechanical forces into the system. After the grinding process, the dispersants have a stabilizing effect on the system as a result of steric or electrostatic interactions. Dispersants may be of anionic, cationic, amphoteric or neutral structure. They can be low molecular weight in nature or constitute higher molecular weight polymers which form a random, alternating, block-like, comb-like or star-shaped arranged architecture of the polymerized monomers.

Examples of commercially important dispersants, which are used in large amounts for producing suspension concentrates, are sulfonated condensation products of alkylnaphthalenes with formaldehyde (naphthalene sulfonates) or lignosulfonates. However, these products no longer satisfy today's requirements as regards toxicological acceptability and user safety since they have a skin and eye irritancy effect. Moreover, these dispersants are not particularly effective, i.e. relatively large amounts are required in order to obtain stable suspension concentrates.

It was therefore an object of the present invention to provide suspension concentrates which are based on dispersants, which permit an adequate stabilization of the suspension concentrate even in small amounts and which are characterized by an advantageous toxicological profile.

Surprisingly, it has now been found that this object is achieved by suspension concentrates comprising

a) one or more pesticides that are solid at room temperature (25° C.) and

b) one or more copolymers selected from the group consisting of copolymers of the formula (CP₁) and copolymers of the formula (CP₂)

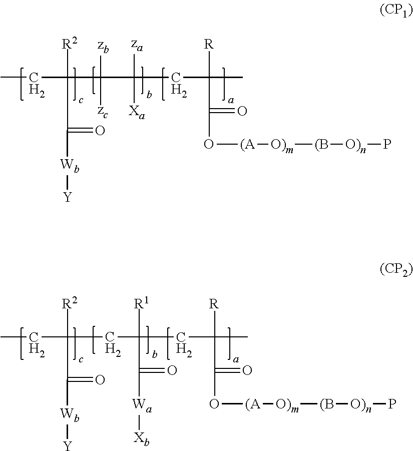

where

the indices a, b and c indicate the molar fraction of the respective structural unit,
a is 0.01-0.8,
b is 0.001-0.8,
c is 0.001-0.8, and
   the sum of a+b+c is 1,
A is C₂-C₄-alkylene,
B is a C₂-C₄-alkylene different from A,
R is hydrogen or methyl,
m is a number from 1 to 500,
n is a number from 1 to 500, and
   the sum m+n is 2 to 1000,
Xₐ is an aromatic or araliphatic radical having 3 to 30, preferably 6 to 30 and particularly preferably 6 to 20, carbon atoms which optionally contains one or more of the heteroatoms N, O and S,
zₐ is H or (C₁-C₄)-alkyl,
z_{b} is H or (C₁-C₄)-alkyl,
z_{c} is H or (C₁-C₄)-alkyl,
R¹ is hydrogen or methyl,
X_{b} is an aromatic or araliphatic radical having 3 to 30, preferably 6 to 30 and particularly preferably 6 to 20, carbon atoms which optionally contains one or more of the heteroatoms N, O and S,
Wₐ is oxygen or the group NH,
R² is hydrogen or methyl,
Y is an aliphatic hydrocarbon radical having 1 to 30 carbon atoms which can be linear or branched, or else cyclic, and can contain the heteroatoms O, N and/or S and can also be unsaturated,
W_{b} is oxygen or the group NH,
P is H, SO₃M, CH₂COOM, PO₃M₂,

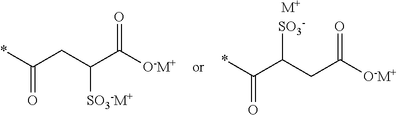

and
M is H, a monovalent metal cation, a divalent metal cation, NH₄⁺, a secondary, tertiary or quaternary ammonium ion, or a combination thereof, or equivalents of di-, tri- or polyvalent metal ions,

and

c) optionally one or more further auxiliaries

and

d) one or more solvents.

The invention therefore provides suspension concentrates comprising

a) one or more pesticides that are solid at room temperature (25° C.) and

b) one or more copolymers selected from the group consisting of copolymers of the formula (CP₁) and copolymers of the formula (CP₂)

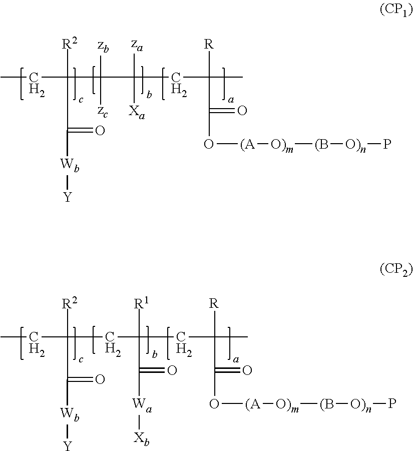

where

the indices a, b and c indicate the molar fraction of the respective structural unit,
a is 0.01-0.8,
b is 0.001-0.8,
c is 0.001-0.8, and
   the sum of a+b+c is 1,
A is C₂-C₄-alkylene,
B is a C₂-C₄-alkylene different from A,
R is hydrogen or methyl,
m is a number from 1 to 500,
n is a number from 1 to 500, and
   the sum m+n is 2 to 1000,
Xₐ is an aromatic or araliphatic radical having 3 to 30, preferably 6 to 30 and particularly preferably 6 to 20, carbon atoms which optionally contains one or more of the heteroatoms N, O and S,
zₐ is H or (C₁-C₄)-alkyl,
z_{b} is H or (C₁-C₄)-alkyl,
z_{c} is H or (C₁-C₄)-alkyl,
R¹ is hydrogen or methyl,
X_{b} is an aromatic or araliphatic radical having 3 to 30, preferably 6 to 30 and particularly preferably 6 to 20, carbon atoms which optionally contains one or more of the heteroatoms N, O and S,
Wₐ is oxygen or the group NH,
R² is hydrogen or methyl,
Y is an aliphatic hydrocarbon radical having 1 to 30 carbon atoms which can be linear or branched, or else cyclic, and can contain the heteroatoms O, N and/or S and can also be unsaturated,
W_{b} is oxygen or the group NH,
P is H, SO₃M, CH₂COOM, PO₃M₂,

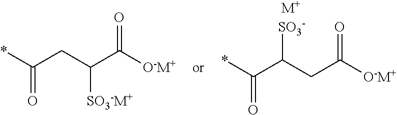

and
M is H, a monovalent metal cation, a divalent metal cation, NH₄⁺, a secondary, tertiary or quaternary ammonium ion, or a combination thereof, or equivalents of di-, tri- or polyvalent metal ions,

and

c) optionally one or more further auxiliaries

and

d) one or more solvents.

The symbol “*” in the sulfosuccinate formulae under the definition of “P” means that the corresponding structural units are bonded to the group -(A-O)ₘ—(B—O)ₙ— in the copolymer b) via the bond labeled with the symbol.

EP 0 007 731 A2 describes the use of copolymers as dispersants in suspension concentrates.

WO 2008/015185 A2 describes copolymers which consist of acrylic acids, 2-acrylamido-2-methylpropanesulfonic acid and acrylic acid esters in certain quantitative ratios and which are suitable as dispersants for pesticide preparations.

WO 2008/036864 A2 discloses the use of water-soluble copolymers as dispersants for water-soluble active ingredients.

WO 2010/121976 A2 describes dispersants for pesticide preparations which are based on a copolymer containing 2-acrylamido-2-methylpropanesulfonic acid.

WO 2008/138485 A1 describes nonionic water-soluble additives which can be used as dispersants for pigments. WO 2008/138486 A1 describes anionic water-soluble additives which can be used as dispersants for pigments. The use as dispersants for pesticides is not described.

Within the context of the present invention, “pesticides” are understood as meaning herbicides, fungicides, insecticides, acaricides, bactericides, molluscicides, nematicides and rodenticides, and phytohormones. Phytohormones control physiological reactions, such as growth, flowering rhythm, cell division and seed ripening. An overview of the most relevant pesticides can be found for example in “The Pesticide Manual” from the British Crop Protection Council, 14^{th} Edition 2006, Editor: C. D. S. Tomlin.

Within the context of the present invention, room temperature means 25° C.

The one or more pesticides of component a) of the suspension concentrates according to the invention are preferably selected from the group consisting of herbicides, insecticides and fungicides.

Preferred fungicides are aliphatic nitrogen fungicides, amide fungicides such as acylaminoacid fungicides or anilide fungicides or benzamide fungicides or strobilurin fungicides, aromatic fungicides, benzimidazole fungicides, benzothiazole fungicides, carbamate fungicides, conazole fungicides such as imidazoles or triazoles, dicarboximide fungicides, dithiocarbamate fungicides, imidazole fungicides, morpholine fungicides, oxazole fungicides, pyrazole fungicides, pyridine fungicides, pyrimidine fungicides, pyrrole fungicides, quinone fungicides.

Preferred herbicides are amide herbicides, anilide herbicides, aromatic acid herbicides such as benzoic acid herbicides or picolinic acid herbicides, benzoylcyclohexanedione herbicides, benzofuranyl alkylsulfonate herbicides, benzothiazole herbicides, carbamate herbicides, carbanilate herbicides, cyclohexene oxime herbicides, cyclopropylisooxazole herbicides, dicarboximide herbicides, dinitroaniline herbicides, dinitrophenol herbicides, diphenyl ether herbicides, dithiocarbamate herbicides, imidazolinone herbicides, nitrile herbicides, organophosphorus herbicides, oxadiazolone herbicides, oxazole herbicides, phenoxy herbicides such as phenoxyacetic acid herbicides or phenoxybutanoic acid herbicides or phenoxypropionic acid herbicides or aryloxyphenoxypropionic acid herbicides, pyrazole herbicides such as benzoylpyrazole herbicides or phenylpyrazole herbicides, pyridazinone herbicides, pyridine herbicides, thiocarbamate herbicides, triazine herbicides, triazinone herbicides, triazole herbicides, triazolone herbicides, triazolopyrimidine herbicides, uracil herbicides, urea herbicides such as phenylurea herbicides or sulfonylurea herbicides.

Preferred insecticides are carbamate insecticides, such as benzofuranyl methyl carbamate insecticides or dimethyl carbamate insecticides or oxime carbamate insecticides or phenyl methyl carbamate insecticides, diamide insecticides, insect growth regulators, macrocyclic lactone insecticides such as avermectin insecticides or milbemycin insecticides or spinosyn insecticides, nereistoxin analogous insecticides, nicotinoide insecticides such as nitroguanidine nicotinoide insecticides or pyridylmethylamine nicotinoide insecticides, organophosphorus insecticides such as organophosphate insecticides or organothiophosphate insecticides or phosphonate insecticides or phosphoramidothioate insecticides, oxadiazine insecticides, pyrazoline insecticides, pyrethroid insecticides such as pyrethroid ester insecticides or pyrethroid ether insecticides or pyrethroid oxime insecticides, tetramic acid insecticides, tetrahydrofuran dione insecticides, thiazole insecticides.

Particularly preferably, the one or more pesticides of component a) of the suspension concentrates according to the invention is/are selected from the group consisting of triazole fungicides, strobilurin fungicides, neonicotinoid insecticides, phenylpyrazole insecticides, benzoylcyclohexanedione herbicides, triazine herbicides and sulfonylurea herbicides.

Particularly preferably, the one or more pesticides of component a) of the suspension concentrates according to the invention is/are selected from the group consisting of epoxiconazole, tebuconazole, azoxystrobin, trifloxystrobin, imidacloprid, thiacloprid, thiamethoxam, fipronil, ethiprol, mesotrione, tembotrione, atrazine, nicosulfurone, iodosulfurone and mesosulfurone.

Within the context of the present invention, the copolymers of the formulae (CP₁) and (CP₂) in which P is H are referred to as nonionic copolymers, and the copolymers of the formulae (CP₁) and (CP₂) in which P has a meaning other than H are referred to as anionic copolymers.

The nonionic copolymers of the formulae (CP₁) and (CP₂) in which P is H are prepared by free-radical polymerization of monomers (A), (B) and (C) corresponding to the structural units described in the brackets [ ]_{c}, [ ]_{b} and [ ]ₐ. The preparation of the nonionic copolymers of the formulae (CP₁) and (CP₂) in which P is H is described in WO 2008/138485 A1. To prepare the anionic copolymers of the formulae (CP₁) and (CP₂) in which P has a meaning other than H, firstly the nonionic copolymers of the formulae (CP₁) and (CP₂) in which P is H are prepared and the resulting nonionic copolymers are then reacted by methods known to the person skilled in the art to give the corresponding anionic copolymers of the formulae (CP₁) and (CP₂) in which P has a meaning other than H. The preparation of the anionic copolymers of the formulae (CP₁) and (CP₂) in which P has a meaning other than H is described in WO 2008/138486 A1.

The molar fraction of the monomers, based on the total amount of the monomers (A), (B) and (C) used for the preparation of the copolymers b), is 1 to 80% for the monomer (A), 0.1 to 80% for the monomer (B), and 0.1 to 80% for the monomer (C). Preferably, the molar fraction of the monomers, based on the total amount of the monomers (A), (B) and (C) used for the preparation of the copolymers b), is 10 to 70% for monomer (A), 10 to 60% for monomer (B) and 10 to 60% for monomer (C).

The monomers (A) can be described by the formula (I):

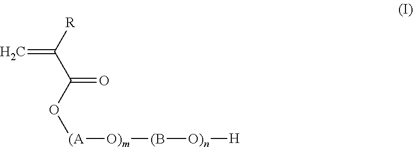

where

A is C₂- to C₄-alkylene and

B is a C₂- to C₄-alkylene different from A,

R is hydrogen or methyl,

m is a number from 1 to 500, preferably 1 to 50,

n is a number from 1 to 500, preferably 1 to 50, and

where the sum m+n is 2 to 1000.

The alkyleneoxy units (A-O)ₘ and (B—O)ₙ can be present either blockwise or in a statistical arrangement. Preferably, the alkyleneoxy units (A-O)ₘ and (B—O)ₙ are present in a blockwise arrangement.

In one preferred embodiment of the invention, (A-O)ₘ is propyleneoxy units and (B—O)ₙ is ethyleneoxy units, or (A-O)ₘ is ethyleneoxy units and (B—O)ₙ is propyleneoxy units, where the molar fraction of the ethyleneoxy units is preferably 50 to 98%, particularly preferably 60 to 95% and especially preferably 70 to 95%, based on the sum (100%) of the ethyleneoxy and propyleneoxy units.

The sum of the alkyleneoxy units n+m is a number from 2 to 1000, preferably from 2 to 500, particularly preferably from 2 to 100 and especially preferably from 5 to 100.

The monomers (B) can be described by the formula (IIa) or formula (IIb):

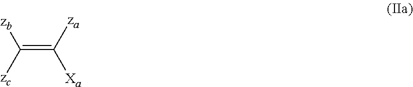

where
Xₐ is an aromatic or araliphatic radical having 3 to 30, preferably 6 to 30 and particularly preferably 6 to 20, carbon atoms, which optionally contains one or more of the heteroatoms N, O and S,
zₐ is H or (C₁-C₄)-alkyl,
z_{b} is H or (C₁-C₄)-alkyl, and
z_{c} is H or (C₁-C₄)-alkyl.

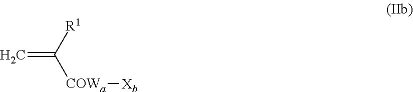

where
R¹ is hydrogen or methyl,
X_{b} is an aromatic or araliphatic radical having 3 to 30, preferably 6 to 30 and particularly preferably 6 to 20, carbon atoms, which optionally contains one or more of the heteroatoms N, O and S, and
Wₐ is oxygen or the group NH.

The monomers (B) of the formula (IIa) include for example vinylaromatic monomers such as styrene and its derivatives such as, for example, vinyltoluene, alpha-methylstyrene. The aromatic unit may also be heteroaromatics, as e.g. in 1-vinylimidazole. Preferably, the monomer (B) of the formula (IIa) is styrene, i.e. zₐ, z_{b} and z_{c} are preferably H and Xₐ is preferably phenyl.

The monomers (B) of the formula (IIb) include for example the following esters and amides of acrylic acid and methacrylic acid: phenyl, benzyl, tolyl, 2-phenoxyethyl, phenethyl.

In a particularly preferred embodiment of the invention, the monomers (B) are selected from: styrene, 1-vinylimidazole, benzyl methacrylate, 2-phenoxyethyl methacrylate and phenethyl methacrylate.

The monomers (C) can be described by the formula (III):

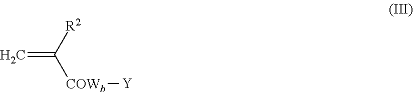

where
R² is hydrogen or methyl,
Y is an aliphatic hydrocarbon radical having 1 to 30, preferably having 6 to 30 and particularly preferably having 9 to 20, carbon atoms, which may be linear or branched, or else cyclic, and can contain the heteroatoms O, N and/or S and can also be unsaturated, and
W_{b} is oxygen or the group NH.

The monomers (C) include for example the following esters and amides of acrylic acid and methacrylic acid: methyl, ethyl, propyl, isopropyl, n-butyl, isobutyl, tert-butyl, pentyl, hexyl, 2-ethylhexyl, 3,3-dimethylbutyl, heptyl, octyl, isooctyl, nonyl, lauryl, myristyl, cetyl, octadecyl or stearyl, behenyl, cyclohexyl, trimethylcyclohexyl, tert-butylcyclohexyl, bornyl, isobornyl, adamantyl, (2,2-dimethyl-1-methyl)propyl, cyclopentyl, 4-ethylcyclohexyl, 2-ethoxyethyl, tetrahydrofurfuryl and tetrahydropyranyl.

Preferred monomers (C) are the following alkyl esters or alkyl amides of acrylic acid and methacrylic acid: methyl, ethyl, propyl, n-butyl, isobutyl, 2-ethylhexyl, lauryl, myristyl, octadecyl and particularly preferably 2-ethylhexyl and lauryl.

In a preferred embodiment of the invention, the one or more copolymers b) are copolymers of the formula (CP₁) or (CP₂) in which P is H.

In a further preferred embodiment of the invention, the one or more copolymers b) are copolymers of the formula (CP₁) or (CP₂) in which P has a meaning other than H.

The copolymers (CP₁) and (CP₂) preferably have a molecular weight of 10³ to 10⁹ g/mol, particularly preferably from 10³ to 10⁷ g/mol and especially preferably from 10³ to 10⁵ g/mol. They have customary terminal groups which are formed by the initiation of the free-radical polymerization or by chain transfer reactions or by chain termination reactions, for example a proton, a group from a free radical initiator or a sulfur-containing group from a chain transfer reagent.

Among the copolymers b), preference is given to the copolymers of the formula (CP₁).

The structural units described in the brackets [ ]_{c}, [ ]_{b} and [ ]ₐ can be present in the one or more copolymers b) for example in a blockwise, statistical, gradient-like or alternating arrangement, and are preferably present in a statistical arrangement.

The suspension concentrates according to the invention comprise the one or more pesticides preferably in an amount of 1 to 80% by weight, particularly preferably in an amount of 5 to 70% by weight and especially preferably in an amount of 10 to 60% by weight. These amounts are based on the total mass of the corresponding suspension concentrate according to the invention.

The amount of the one or more copolymers of the formulae (CP₁) or (CP₂) in the suspension concentrates according to the invention is preferably from 0.05 to 10% by weight, particularly preferably from 0.1 to 5% by weight and especially preferably from 0.2 to 5% by weight. These amounts are based on the total mass of the corresponding suspension concentrate according to the invention.

If the suspension concentrates according to the invention comprise one or more auxiliaries c), their amount in the suspension concentrates according to the invention is preferably from 1 to 50% by weight, particularly preferably from 2 to 40% by weight and especially preferably from 4 to 30% by weight. These amounts are based on the total mass of the corresponding suspension concentrate according to the invention.

The suspension concentrates according to the invention comprise one or more solvents d). They can for example comprise water as the sole solvent, one or more organic solvents on their own such as, for example, one or more water-immiscible solvents or else combinations of water and one or more organic solvents, such as, for example, combinations of water and one or more water-immiscible solvents.

In a preferred embodiment of the invention, the one or more solvents d) in the suspension concentrates according to the invention comprising the components a), b) and c) and optionally additionally one or more water-soluble pesticides different from the pesticides a) and having a solubility in water of more than 50 g/l at room temperature (pesticide a2)) is/are present in an amount ad 100%.

In a further preferred embodiment of the invention, the amount of the one or more solvents d) in the suspension concentrates according to the invention is preferably from 10 to 90% by weight, particularly preferably from 20 to 85% by weight and especially preferably from 30 to 80% by weight. These amounts are based on the total mass of the corresponding suspension concentrate according to the invention.

If the suspension concentrates according to the invention comprise water and additionally one or more organic solvents such as, for example, one or more water-immiscible solvents, the weight ratio of water to the one or more organic solvents such as, for example, the one or more water-immiscible solvents, is from 50:1 to 1:50, particularly preferably from 20:1 to 1:20 and especially preferably from 10:1 to 1:10.

Besides the use in suspension concentrates, the copolymers of the formulae (CP₁) or (CP₂) can also be used in solid formulations of pesticides such as WGs (“wettable granules”, water-dispersible granules) and WPs (“wettable powders”, water-dispersible powders).

The auxiliaries c) optionally present in the suspension concentrates according to the invention may be further dispersants, wetting agents, emulsifiers, thickeners, preservatives, adjuvants, penetration promoters, low-temperature stabilizers, colorants, antifoams and antioxidants.

Suitable further dispersants and wetting agents are all substances that can customarily be used for this purpose in agrochemical formulations, such as nonionic, amphoteric, cationic and anionic (polymeric) surfactants.

Preferred further dispersants and wetting agents are fatty alcohol ethoxylates, fatty alcohol alkoxylates, EO/PO block copolymers (EO: ethyleneoxy unit; PO: propyleneoxy unit), alkylarylsulfonic acids, alkylsulfonic acids, sulfonic acids of ethoxylated alcohols, sulfosuccinates, fatty acid methyl taurides, tristyrylphenol ethoxylates and alkoxylates, tri-sec-butylphenol ethoxylates, sulfated cresol-formaldehyde condensation products, sulfated condensation products of naphthalene and alkylnaphthalenes, lignosulfonates, phosphoric acid esters of ethoxylated fatty alcohols, tristyrylphenols and tri-sec-butylphenols, and ether sulfates of ethoxylated fatty alcohols, tristyrylphenols and tri-sec-butylphenols and polymeric dispersants.

Suitable emulsifiers are nonionic and anionic emulsifiers such as ethoxylates or alkoxylates of long-chain (C₈ to C₂₄) linear or branched alcohols, EO/PO block copolymers (EO: ethyleneoxy unit; PO: propyleneoxy unit), alkylphenol or tristyrylphenol ethoxylates and alkoxylates, tri-sec-butylphenol ethoxylates, castor oil ethoxylates, esters of long-chain carboxylic acids with mono- or polyhydric alcohols, and ethoxylation products thereof, salts of dodecylbenzenesulfonic acid, sulfosuccinates, phosphoric acid esters of ethoxylated fatty alcohols, tristyrylphenols and tri-sec-butylphenols and salts thereof.

Thickeners which can be used are all substances that can usually be used for this purpose in agrochemical formulations, such as xanthan gum and/or cellulose, for example carboxy-, methyl-, ethyl- or propylcellulose, (optionally modified) bentonites and silicondioxide or thickening polymers or copolymers.

Preservatives which can be used are all substances that can usually be used for this purpose in agrochemical formulations, such as organic acids and their esters, for example ascorbic acid, ascorbic palmitate, sorbate, benzoic acid, methyl and propyl 4-hydroxybenzoate, propionates, phenol, for example 2-phenylphenate, 1,2-benzisothiazolin-3-one, formaldehyde, sulfurous acid and salts thereof.

Adjuvants which can be used are all substances that can customarily be used for this purpose in agrochemical formulations, such as optionally crosslinked polyglycerol esters, alcohol alkoxylates such as e.g. alcohol ethoxylates, alkyl polysaccharides, fatty amine ethoxylates, esters or phosphorous acid or of phosphoric acid such as bis(ethylhexyl) ethylhexylphosphonate or tris(ethylhexyl) phosphate, sorbitan and sorbitol ethoxylate derivatives.

Suitable penetration promoters are all substances which are usually used in order to improve the penetration of pesticides into plants or into target organisms. Penetration promoters can be defined for example by the fact that they penetrate into the cuticle of the plant from the aqueous spray liquor and/or from a spray covering on the plant surface and are thereby able to increase the mobility of active ingredients in the cuticle. The method described in the literature can be used for determining this property (Baur et al., 1997, Pesticide Science 51, 131-152).

Low-temperature stabilizers may be all substances that can customarily be used for this purpose in agrochemical formulations. By way of example, mention may be made of urea, glycerol and propylene glycol. Suitable colorants are all substances that can customarily be used for this purpose in agrochemical formulations, such as water- or oil-soluble dyes, and also organic or inorganic pigments. Suitable antifoams are all substances that can customarily be used for this purpose in agrochemical formulations, such as fatty acid alkyl ester alkoxylates; organopolysiloxanes such as polydimethylsiloxanes and mixtures thereof with microfine, optionally silanized silica; perfluoroalkylphosphonates and -phosphinates; paraffins; waxes and microcrystalline waxes and mixtures thereof with silanized silica. Mixtures of different foam inhibitors, for example those of silicone oil, paraffin oil and/or waxes are also advantageous. Suitable antioxidants are all substances that can customarily be used for this purpose in agrochemical formulations, such as, for example, BHT (2,6-di-tert-butyl-4-methylphenol).

The suspension concentrates according to the invention preferably comprise one or more auxiliaries of component c).

Within the context of this invention, suspension concentrates are to be understood as meaning all dispersions of pesticides, irrespective of whether only water is present as solvent, whether an organic solvent on its own is present or combinations of both solvents, i.e. of water and an organic solvent, are present.

In the narrower sense, suspension concentrates are often understood as only meaning aqueous dispersions of pesticides. These are referred to as “suspension concentrate” and are usually abbreviated with the shorthand “SC”.

In a further preferred embodiment of the invention, the suspension concentrates according to the invention therefore comprise
a) one or more pesticides that are solid at room temperature and
b) one or more copolymers selected from the group consisting of copolymers of the formula (CP₁) and copolymers of the formula (CP₂) and
c) optionally one or more further auxiliaries and
d) water as the sole solvent.

The preparation of stable aqueous suspension concentrates is particularly complex if one or more further water-soluble pesticides are present besides the water-dispersed (water-insoluble) pesticide. These water-soluble pesticides (such as glyphosate) have a salt character, which leads to problems for the customarily used dispersants, which is evident from thickening of the suspension concentrate or separation into a plurality of phases and/or precipitations. Surprisingly, the copolymers (CP₁) and (CP₂) are also particularly well suited for producing suspension concentrates which also comprise one or more water-soluble salt-like pesticides as well as the one or more dispersed pesticides that are solid at room temperature.

In a further preferred embodiment of the invention, the suspension concentrates according to the invention therefore comprise
a) one or more pesticides that are solid at room temperature and
a2) one or more water-soluble pesticides that are different from the pesticides a) and have a solubility in water of more than 50 g/l at room temperature and
b) one or more copolymers selected from the group consisting of copolymers of the formula (CP₁) and copolymers of the formula (CP₂) and
c) optionally one or more further auxiliaries and
d) water as the sole solvent.

Particularly preferably, the one or more water-soluble pesticides a2) is/are selected from water-soluble salts of herbicides and especially preferably they are selected from the group consisting of water-soluble salts of N-phosphonomethylglycine (glyphosate), glufosinate, 2,4-D, dicamba, bentazone and MCPA.

If the suspension concentrates according to the invention comprise one or more water-soluble pesticides a2) having a solubility in water of more than 50 g/l at room temperature, their amount in the suspension concentrates according to the invention is preferably from 0.1 to 50% by weight, particularly preferably from 1 to 40% by weight and especially preferably from 5 to 30% by weight. These amounts are based on the total mass of the corresponding suspension concentrate according to the invention.

As well as the aqueous suspension concentrates, there are also anhydrous suspension concentrates. These are also known under the name oil dispersions (and abbreviated with the shorthand “OD”). In oil dispersions, the pesticides are dispersed in a water-immiscible solvent (the “oil”). However, the oil does not have to be an oil in the classic sense (such as a mineral oil or vegetable oil). Rather, it is understood as meaning any water-immiscible solvent. This preparation form is suitable for example particularly for hydrolysis-sensitive active ingredients, such as, for example, sulfonylurea herbicides, which decompose in the presence of water over time. In addition, oil dispersions have the advantage that they are often characterized by a higher biological effectiveness. Certain neonicotinoide insecticides are therefore more often formulated as an oil dispersion.

In a further preferred embodiment of the invention, the suspension concentrates according to the invention therefore comprise
a) one or more pesticides that are solid at room temperature and
b) one or more copolymers selected from the group consisting of copolymers of the formula (CP₁) and copolymers of the formula (CP₂) and
c) optionally one or more further auxiliaries and
d) one or more water-immiscible solvents,

and are characterized in that they comprise either no water or comprise water in an amount of less than or equal to 1.0% by weight, based on the total amount of the respective suspension concentrate.

Within the context of the present invention, “anhydrous” suspension concentrates are understood as meaning those which either comprise no water or comprise water in an amount of less than or equal to 1.0% by weight, based on the total weight of the respective suspension concentrate. Preferably, the anhydrous suspension concentrates according to the invention comprise less than 0.5% by weight of water, based on the total weight of the respective suspension concentrate. These water contents usually result from residual amounts of water which are present in the solvents or auxiliaries used or are introduced as impurity during the process in the course of producing the compositions.

Within the context of this invention, water-immiscible solvents are understood as meaning solvents which, at room temperature, have a solubility of at most 5% by weight, preferably of at most 1% by weight, in water.

Examples of such solvents are alkanes, aromatic hydrocarbons, solvent naphtha, alcohols, esters, ketones, amides, ethers, phosphoric and phosphonic acid esters, vegetable oils, mineral oils, alkyl esters of fatty acids of vegetable or animal origin.

They are preferably solvent naphtha, fatty acid amides, vegetable oils, mineral oils, and short-chain esters of fatty acids of vegetable or animal origin.

Moreover, there are also suspension concentrates which comprise both water and also water-immiscible solvents. These are referred to as suspoemulsion (SE). Here, only the aqueous phase can contain at least one pesticide in dispersed form. The non-aqueous phase then contains the water-immiscible solvent and also auxiliaries (such as, for example, emulsifiers). However, suspoemulsions often contain at least one pesticide both in the aqueous and in the non-aqueous phase. Then, at least one sparingly soluble pesticide is present in dispersed form in the aqueous phase and at least one pesticide soluble in the solvent is present in dissolved form in the solvent phase of the water-immiscible solvent.

In a further preferred embodiment of the invention, the suspension concentrates according to the invention therefore comprise
a) one or more pesticides that are solid at room temperature and
b) one or more copolymers selected from the group consisting of copolymers of the formula (CP₁) and copolymers of the formula (CP₂) and
c) optionally one or more further auxiliaries and
d) water and one or more water-immiscible solvents.

Within the context of this invention, preferred auxiliaries c) are copolymers as described in EP 1 379 129 B1. These auxiliaries have the advantage that they have both a wetting and dispersing effect and can additionally function as adjuvant.

In a further preferred embodiment of the invention, the suspension concentrates according to the invention therefore comprise
a) one or more pesticides that are solid at room temperature and
b) one or more copolymers selected from the group consisting of copolymers of the formula (CP₁) and copolymers of the formula (CP₂) and
c) one or more copolymers obtainable by copolymerization of glycerol, at least one dicarboxylic acid and at least one monocarboxylic acid and
   optionally one or more further auxiliaries that are different from said copolymers and
d) one or more solvents.

Preferably, the copolymers just mentioned are copolymers obtainable by copolymerization of
alpha) 19.9 to 99% by weight of glycerol and
beta) 0.1 to 30% by weight of at least one dicarboxylic acid and
gamma) 0.9 to 80% by weight of at least one monocarboxylic acid according to formula (I)

R¹—COOH (I)

where R¹ is (C₅-C₂₉)-alkyl; (C₇-C₂₉)-alkenyl; phenyl or naphthyl.

Preferably, the dicarboxylic acid beta) is oxalic acid; a dicarboxylic acid according to formula (II)

HOOC—R²—COOH (II)

and/or a dicarboxylic acid according to formula (III)

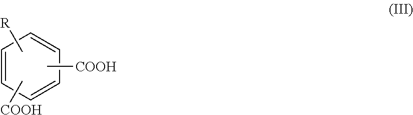

where R² is a (C₁-C₄₀)-alkylene bridge or a (C₂-C₂₀)-alkenylene bridge, and R is H, (C₁-C₂₀)-alkyl, (C₂-C₂₀)-alkenyl, phenyl, benzyl, halogen, —NO₂, (C₁-C₆)-alkoxy, —CHO or —CO((C₁-C₆)-alkyl).

In one particularly preferred embodiment of the invention, the dicarboxylic acid beta) is phthalic acid and the monocarboxylic acid gamma) is coconut fatty acid.

If the suspension concentrates according to the invention comprise one or more copolymers obtainable by copolymerization of glycerol, at least one dicarboxylic acid and at least one monocarboxylic acid, their amount in the suspension concentrates according to the invention is preferably from 0.1 to 25% by weight, particularly preferably from 0.5 to 20% by weight and especially preferably from 1 to 15% by weight. These amounts are based on the total mass of the corresponding suspension concentrate according to the invention.

The preparation of aqueous and nonaqueous suspension concentrates and also of suspoemulsions is sufficiently known to the person skilled in the art.

The suspension concentrates according to the invention are advantageously suitable for use as crop protection compositions.

The present invention therefore further provides the use of a suspension concentrate according to the invention as crop protection composition.

### EXAMPLES

The invention is illustrated below by reference to examples, although these are in no way to be considered to be a limitation.

The commercial products used are:
Calsogen® AR 100: branched Ca dodecylbenzylsulfonate in Solvesso® 200 from Clariant (50% strength by weight)
Dispersogen® LFS: triethanolammonium salt of an ethoxylated TSP phosphate from Clariant (96% strength by weight); TSP: tristyrylphenol
Dispersogen® 1494: sulfated cresol-formaldehyde condensation product from Clariant (35% strength by weight in water)
Emulsogen® SF 8: sodium dioctylsulfosuccinate from Clariant (50% strength by weight in water)
Emulsogen® TS 200: ethoxylated tristyrylphenol (20 EO) from Clariant
Genapol® PF 40: ethylene oxide/propylene oxide copolymer from Clariant
Genapol® T 150: C_{16/18}-fatty alcohol ethoxylate (15 EO) from Clariant
Hostapon® TPHC: sodium salt of a fatty acid methyltauride from Clariant (63% strength by weight)
Kelzan® S: xanthan gum from CP Kelco (thickener)
Sapogenat® T 060: ethoxylated tri(sec-butyl)phenol (6 EO) from Clariant
Silfoam® SE 57: silicone antifoam from Wacker-Chemie
Sovlesso® 200 ND: aromatic hydrocarbon mixture from Exxon

General Method for the Preparation of Suspension Concentrates:

All of the components (apart from the Kelzan® S solution) are predispersed using a dissolver. The subsequent fine grinding takes place in a bead mill until the desired particle size is reached. The aqueous Kelzan® S solution is then added and adjusted to the desired end viscosity. In the case of the suspoemulsion, the water-immiscible solvent is pre-emulsified together with emulsifier and water separately from the aqueous pesticide suspension and likewise added only after the dispersion step. In the case of the atrazine-glyphosate combination formulation, firstly only the aqueous suspension concentrate of the atrazine is prepared and this is then mixed with the aqueous glyphosate solution.

### Example 1

### Suspension Concentrate with Atrazine (Atrazine 500 SC)

| | | |
|---|---|---|
| 202.0 | g | atrazine (99% strength by weight) |
| 2.6 | g | copolymer (prepared according to synthesis example 3 from |
| | | WO 2008/138485 A1) |
| 6.1 | g | Emulsogen ® SF 8 |
| 24.0 | g | propylene glycol |
| 2.0 | g | Silfoam ® SE 57 |
| 32.0 | g | Kelzan ® S (2% strength by weight solution in water) |
| 183.3 | g | deionized water. |

### Example 2

### Suspension Concentrate with Atrazine (Atrazine 500 SC)

| | | |
|---|---|---|
| 202.0 | g | atrazine (99% strength by weight) |
| 1.8 | g | copolymer (prepared according to synthesis example 19 from |
| | | WO 2008/138486 A1) |
| 12.7 | g | copolymer (prepared according to the procedure for |
| | | copolymer II from EP 1 379 129 B1) |
| 20.0 | g | propylene glycol |
| 2.4 | g | Silfoam ® SE 57 |
| 34.0 | g | Kelzan ® S (2% strength by weight solution in water) |
| 178.0 | g | deionized water. |

### Example 3

### Suspension Concentrate with Azoxystrobin (Azoxystrobin 250 SC)

| | | |
|---|---|---|
| 128.2 | g | azoxystrobin (97% strength by weight) |
| 2.7 | g | copolymer (prepared according to synthesis example 3 from |
| | | WO 2008/138485 A1) |
| 21.9 | g | copolymer (prepared according to the procedure for |
| | | copolymer II from EP 1 379 129 B1) |
| 27.0 | 9 | Genapole T 150 |
| 30.0 | g | propylene glycol |
| 3.5 | g | Silfoam ® SE 57 |
| 50.0 | g | Kelzan ® S (2% strength by weight solution in water) |
| 276.0 | g | deionized water. |

### Example 4

### Suspension Concentrate with Azoxystrobin (Azoxystrobin 250 SC)

| | | |
|---|---|---|
| 128.2 | g | azoxystrobin (97% strength by weight) |
| 3.5 | g | copolymer (prepared according to synthesis example 7 from |
| | | WO 2008/138485 A1) |
| 18.8 | g | Hostapon ® TPHC |
| 10.8 | g | Dispersogen ® LFS |
| 30.0 | g | propylene glycol |
| 3.5 | g | Silfoam ® SE 57 |
| 50.0 | g | Kelzan ® S (2% strength by weight solution in water) |
| 295.0 | g | deionized water. |

### Example 5

### Suspension Concentrate with Imidacloprid (Imidacloprid 350 SC)

| | | |
|---|---|---|
| 184.0 | g | imidacloprid (95% strength by weight) |
| 9.2 | g | copolymer (prepared according to synthesis example 17 from |
| | | WO 2008/138486 A1) |
| 29.2 | g | Emulsogen ® TS 200 |
| 11.0 | g | Dispersogen ® 1494 |
| 30.0 | g | propylene glycol |
| 7.5 | g | Silfoam ® SE 57 |
| 45.0 | g | Kelzan ® S (2% strength by weight solution in water) |
| 315.0 | g | deionized water. |

### Example 6

### Suspension Concentrate with Tebuconazol (Tebuconazol 430 SC)

| | | |
|---|---|---|
| 221.6 | g | tebuconazol (97% strength by weight) |
| 2.5 | g | copolymer (prepared according to synthesis example 3 from |
| | | WO 2008/138486 A1) |
| 8.7 | g | Dispersogen ® LFS |
| 7.0 | g | Genapol ® PF 40 |
| 30.0 | g | propylene glycol |
| 3.0 | g | Silfoam ® SE 57 |
| 60.0 | g | Kelzan ® S (2% strength by weight solution in water) |
| 250.0 | g | deionized water. |

### Example 7

### Suspoemulsion with Epoxiconazole (Epoxiconazole 125 SE)

| | | |
|---|---|---|
| 129.0 | g | epoxiconazole (97% strength by weight) |
| 250.0 | g | Sapogenat ® T 060 |
| 167.0 | g | Solvesso ® 200 ND |
| 45.5 | g | Calsogen ® AR 100 |
| 17.1 | g | copolymer (prepared according to synthesis example 19 from |
| | | WO 2008/138486 A1) |
| 30.0 | g | propylene glycol |
| 3.0 | g | Silfoam ® SE 57 |
| 45.0 | g | Kelzan ® S (2% strength by weight solution in water) |
| 365.0 | g | deionized water. |

### Example 8

### Suspension Concentrate with a Water-Soluble Pesticide (Atrazine-Glyphosate Combination Formulation)

| | | |
|---|---|---|
| 202.0 | g | atrazine (99% strength by weight) |
| 4.8 | g | copolymer (prepared according to synthesis example 19 from |
| | | WO 2008/138486 A1) |
| 13.3 | g | copolymer (prepared according to the procedure for |
| | | copolymer II from EP 1 379 129 B1) |
| 20.0 | g | propylene glycol |
| 2.4 | g | Silfoam ® SE 57 |
| 34.0 | g | Kelzan ® S (2% strength by weight solution in water) |
| 159.6 | g | glyphosate-isopropylammonium salt solution (62% strength |
| | | by weight in water) |
| 34.0 | g | deionized water. |

The suspendability of the prepared suspension concentrates from examples 1 to 8 is determined in accordance with CIPAC method MT 184 by dilution to 0.5% by weight in 342 ppm of CIPAC standard water after 30 minutes. All of the suspension concentrates had a suspendability of >80%.

The prepared suspension concentrates are stored for 14 days at room temperature (25° C.), then the appearance is assessed. All of the suspension concentrates are storage-stable.

1. A suspension concentrate comprising
a) at least one pesticide that is solid at room temperature (25° C.) and
b) at least one copolymer selected from the group consisting of copolymers of the formula (CP₁) and copolymers of the formula (CP₂) 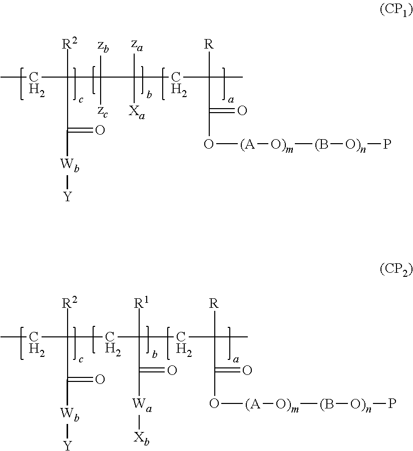
where
the indices a, b and c indicate the molar fraction of the respective structural unit,
a is 0.01-0.8,
b is 0.001-0.8,
c is 0.001-0.8, and
the sum of a+b+c is 1,
A is C₂-C₄-alkylene,
B is a C₂-C₄-alkylene different from A,
R is hydrogen or methyl,
m is a number from 1 to 500,
n is a number from 1 to 500, and
the sum m+n is 2 to 1000,
Xₐ is an aromatic or araliphatic radical having 3 to 30 carbon atoms which optionally contains one or more of the heteroatoms N, O and S,
zₐ is H or (C₁-C₄)-alkyl,
z_{b} is H or (C₁-C₄)-alkyl,
z_{c} is H or (C₁-C₄)-alkyl,
R¹ is hydrogen or methyl,
X_{b} is an aromatic or araliphatic radical having 3 to 30 carbon atoms which optionally contains one or more of the heteroatoms N, O and S,
Wₐ is oxygen or the group NH,
R² is hydrogen or methyl,
Y is an aliphatic hydrocarbon radical having 1 to 30 carbon atoms which can be linear or branched, or else cyclic, and can contain the heteroatoms O, N and/or S and can also be unsaturated,
W_{b} is oxygen or the group NH,
P is H, SO₃M, CH₂COOM, PO₃M₂, 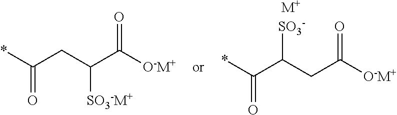
and
M is H, a monovalent metal cation, a divalent metal cation, NH₄⁺, a secondary, tertiary or quaternary ammonium ion, or a combination thereof, or equivalents of di-, tri- or polyvalent metal ions,
and
c) optionally at least one further auxiliary,
and
d) at least one solvent.

2. The suspension concentrate as claimed in claim 1, wherein the at least one pesticide of component a) that is solid at room temperature is selected from the group consisting of triazole fungicides, strobilurin fungicides, neonicotinoide insecticides, phenylpyrazole insecticides, benzoylcyclohexanedione herbicides, triazine herbicides and sulfonylurea herbicides.

3. The suspension concentrate as claimed in claim 2, wherein the at least one pesticide of component a) that is solid at room temperature are selected from the group consisting of epoxiconazole, tebuconazole, azoxystrobin, trifloxystrobin, imidacloprid, thiacloprid, thiamethoxam, fipronil, ethiprol, mesotrione, tembotrione, atrazine, nicosulfurone, iodosulfurone and mesosulfurone.

4. The suspension concentrate as claimed in claim 1, comprising
a) at least one pesticide that is solid at room temperature and
b) at least one copolymer selected from the group consisting of copolymers of the formula (CP₁) and copolymers of the formula (CP₂) and
c) optionally at least one further auxiliary, and
d) water as the only solvent.

5. The suspension concentrate as claimed in claim 4, comprising
a) at least one pesticide that is solid at room temperature and
a2) at least one water-soluble pesticide that is different from the pesticide a) and has a solubility in water of more than 50 g/l at room temperature and
b) at least one copolymer selected from the group consisting of copolymers of the formula (CP₁) and copolymers of the formula (CP₂) and
c) optionally at least one further auxiliary, and
d) water as the only solvent.

6. The suspension concentrate as claimed in claim 5, wherein the at least one water-soluble pesticide a2) is selected from the group consisting of water-soluble salts of herbicides.

7. The suspension concentrate as claimed in claim 1, comprising
a) at least one pesticide that is solid at room temperature and
b) one or more copolymers selected from the group consisting of copolymers of the formula (CP₁) and copolymers of the formula (CP₂) and
c) optionally at least one further auxiliary, and
d) at least one water-immiscible solvent,
wherein the suspension concentrate comprises either no water or comprises water in an amount of less than or equal to 1.0% by weight, based on the total weight of the suspension concentrate.

8. The suspension concentrate as claimed in claim 1, comprising
a) at least one pesticide that is solid at room temperature and
b) at least one copolymer selected from the group consisting of copolymers of the formula (CP₁) and copolymers of the formula (CP₂) and
c) optionally at least one further auxiliary, and
d) water and at least one water-immiscible solvent.

9. The suspension concentrate as claimed in claim 1, comprising
a) at least one pesticide that is solid at room temperature and
b) at least one copolymer selected from the group consisting of copolymers of the formula (CP₁) and copolymers of the formula (CP₂) and
c) at least one copolymer obtainable by copolymerization of glycerol, at least one dicarboxylic acid and at least one monocarboxylic acid and optionally at least one further auxiliary, and
d) at least one solvent.

10. A process for crop protection comprising the step of contacting a crop with at least one suspension concentrate as claimed in claim 1.

11. The suspension concentrate as claimed in claim 5, wherein the at least one water-soluble pesticide a2) is selected from the group consisting of water-soluble salts of N-phosphonomethylglycine (glyphosate), glufosinate, 2,4-D, dicamba, bentazone and MCPA.
